(19) United States
(12) Patent Application Publication
(10) Pub. No.: US 2017/0118023 A1
(43) Pub. Date: Apr. 27, 2017

(54) METHOD FOR AUTHORIZING A SOFTWARE UPDATE IN A MOTOR VEHICLE

(71) Applicant: FORD GLOBAL TECHNOLOGIES, LLC, Dearborn, MI (US)

(72) Inventors: Uwe GUSSEN, Huetgenwald (DE); Georg NEUGEBAUER, Herzogenrath (DE); Goetz-Philipp WEGNER, Dortmund (DE); Rainer BUSCH, Aachen (DE)

(73) Assignee: FORD GLOBAL TECHNOLOGIES, LLC, Dearborn, MI (US)

(21) Appl. No.: 15/298,961

(22) Filed: Oct. 20, 2016

(30) Foreign Application Priority Data
Oct. 21, 2015 (DE) 10 2015 220 489.8

(51) Int. Cl. H04L 9/32; G06F 21/62; H04L 29/06; G06F 9/445; H04L 29/08

(52) U.S. Cl. CPC H04L 9/32; G06F 8/65; H04L 67/12; H04L 63/0492; G06F 21/6218; H04L 63/06

(57) ABSTRACT

A software package is stored on an electronic data memory of the motor vehicle. A near field communication is established between a local communication apparatus and a mobile apparatus. The software package is at least partially updated responsive to a successful authorization performed over the established near field communication between the local communication apparatus and the mobile apparatus.

### CROSS-REFERENCE TO RELATED APPLICATIONS

This application claims foreign priority benefits under 35 U.S.C. §119(a)-(d) to DE 10 2015 220 489.8 filed Oct. 21, 2015, which is hereby incorporated by reference in its entirety.

### TECHNICAL FIELD

The present disclosure relates to a method for authorizing a software update in a motor vehicle.

### BACKGROUND

Motor vehicles have an increasing number of microprocessor-based electronic systems which are distinguished by the fact that, in addition to hardware, they also have software running on the microprocessor. Such systems are also referred to as “embedded systems” and concern virtually all areas of motor vehicle electronics, for instance driver assistance systems, infotainment systems, drive train systems, battery management, in particular for electric and hybrid vehicles, and many other areas. With increasing complexity of the software used here, the need to provide software updates, like in the area of software for home computers, is increasing, to be precise both for the purpose of extending the functionality and for the purpose of eliminating bugs and security gaps.

In this case, one possibility known from the prior art provides for such software updates to be carried out when visiting an authorized workshop, for instance on the occasion of an inspection. In such an environment, it is then possible to carry out the update securely and largely without the risk of misuse. However, it is not ensured that all operators, or with increasing age of the motor vehicle, only the majority of operators of a motor vehicle visit such authorized workshops. In addition, the duration of the corresponding service intervals is regularly one year, with the result that, even if an authorized workshop were visited regularly, such an update could be carried out only after a relatively long time. In contrast, special recalls for such updates are very expensive.

In order to also be able to carry out software updates via mobile data transmission, US 2015/0128123 A1 from the prior art shows a method for updating the software of electronic systems in a motor vehicle by means of data transmission via radio. It is therefore no longer necessary to visit a workshop. However, the update, and therefore the exchange of software, in a motor vehicle is highly security-critical. Manipulation of the software running in a motor vehicle by unauthorized persons can immediately adversely affect the traffic safety of the motor vehicle. In this case, the practice of carrying out an update via radio has the risk of forming a gateway for such manipulation. US 2015/0128123 A1 does not disclose any special security measures in this context.

US 2015/0121457 A1 which is likewise known from the prior art likewise describes a method for updating software of electronic systems in a motor vehicle by means of data transmission via radio. An authentication module which authenticates the update data is provided for authorizing the update. In this case, the authentication module may communicate with other modules using various wireless and wired network protocols which are common in the motor vehicle.

The disadvantage of the approaches known from the prior art is overall the fact that a mechanism is not provided which prevents the update from being carried out, for instance, when the motor vehicle is stolen in the parked state. Vehicles which have just been stolen may form a gateway to the effect that the update behavior and its mechanisms are analyzed with the aim of finding weak points. Furthermore, the impossibility of updating the software of motor vehicles which have not been legally obtained acts as a deterrent both for thieves and for potential buyers of stolen vehicles.

### SUMMARY

The object of the disclosure is therefore to improve methods known from the prior art for authorizing a software update in a motor vehicle with respect to unauthorized hacking.

The method according to the disclosure is used to authorize a software update in a motor vehicle. In this case, authorize means checking for the presence of an entitlement to the software update. In this case, the authorization process may comprise authenticating data assigned to the process to be authorized. In the method according to the proposal, the motor vehicle has an electronic data memory with a software package stored in the latter. The electronic data memory may belong to any desired vehicle electronic apparatus in the motor vehicle. In the method according to the disclosure, authorization for at least partially updating the software package is carried out. In other words, at least some of the data in the software package is therefore replaced with the updated data or the software package is supplemented with the updated data. The software package is updated upon successful authorization. Authorization is successful when the presence of the entitlement is positively determined.

The method according to the disclosure is characterized in that the motor vehicle has a local communication apparatus for near field communication. Here and in the text below, the term “near field communication” can be understood as meaning communication by radio with a maximum range of 50 cm, in particular with a maximum range of 10 cm. This is preferably communication by radio according to the international “near field communication” transmission standard which is standardized in the document ETSI TS 102 190. The method according to the disclosure is also characterized in that successful authorization is based on the fact that the local communication apparatus establishes near field communication with a portable mobile apparatus. The portable mobile apparatus may be any desired portable object which has the ability for such near field communication. Mobile telephones, PDAs (personal digital assistants), electronic watches or else automobile keys or pieces of jewelry having communication functions come into consideration here, in particular.

In this manner, authorization can be coupled to such a personal item belonging to the owner of the automobile, in the case of which item it can be assumed that, when near field communication takes place with said item, the owner is also in the motor vehicle. Conversely, it can be assumed that, if the motor vehicle is stolen in an unauthorized manner—for example in the event of theft of a parked motor vehicle—this personal item is not concomitantly stolen since it is usually carried by the owner when he leaves the motor vehicle. The mechanical coupling to an item belonging to the vehicle owner, which has been known for a long time for the purpose of switching on the ignition, is therefore now applied to the update, to be precise on the basis of near field communication by radio.

Accordingly, the motor vehicle according to the disclosure comprises an electronic data memory with a software package stored in the latter and an authorization apparatus for authorizing an at least partial update of the software package. The software package is updated upon successful authorization. The motor vehicle according to the disclosure is characterized in that the motor vehicle has a local communication apparatus for near field communication and successful authorization is based on the fact that the local communication apparatus establishes near field communication with a portable mobile apparatus.

One preferred configuration provides for the motor vehicle to have a teleapparatus for wirelessly receiving a data record for updating the software package from an update server. This data record provides the data which are used to at least partially replace or supplement the software package. In addition to the wireless reception, the teleapparatus may also be set up to wirelessly transmit data to the update server. In this case, it is also possible to communicate indirectly with the update server, with the result that a radio connection to a base station is therefore established and, further, communication with the update server is established via one or more other networks. In particular, the wireless reception of the data record from the update server may comprise transmission via the Internet.

It is further preferred here for the update server to transmit the data record for updating the software package in a broadcast to a multiplicity of teleapparatuses of motor vehicles. In this manner, the data record for updating the software package can be simultaneously transmitted to a plurality of motor vehicles, which both accelerates the transmission process and is efficient with regard to the transmission bandwidth.

In order to update the software package, data are preferably transmitted between the teleapparatus and the update server, the transmitted data being cryptographically protected, and at least one partial key being provided by the mobile apparatus for cryptographically protecting the data. This transmission can be carried out only in one direction—that is to say from the teleapparatus to the update server or from the update server to the teleapparatus—or else in both directions. The cryptographic protection may fundamentally comprise both encryption of the data and signing of the data or another cryptographic measure. The partial key can also form the complete key assigned to the cryptographic protection. In particular, this partial key and the cryptographic protection may concern both data transmitted from the teleapparatus to the update server and data received by the teleapparatus from the update server. These cryptographically protected data can fundamentally be any desired such data transmitted between the teleapparatus and the update server.

It is further preferred here for the cryptographically protected data to comprise the data record for updating the software package, for the cryptographic protection to comprise encryption, and for authorization to comprise decrypting the data record for updating the software package. In other words, these are also in any case the data which are intended to be used to at least partially replace or supplement the software package and are cryptographically protected by means of encryption. This ensures that successful authorization is already a prerequisite for reading the unencrypted data. It is conceivable for the authorization process to consist—only—of decrypting the data record for updating, that is to say authorization is successful insofar as the data record for updating can be decrypted. In this respect, in the narrower sense, there is therefore no absolute need for a decision regarding whether authorization was successful, but rather this is then measured only by the actual success of the decryption. The contribution of the mobile apparatus in such a case is that near field communication with it is established and the mobile apparatus provides the partial key.

In principle, the above partial key can be transmitted in any desired manner from the mobile apparatus to an apparatus responsible for processing the cryptographically protected data. One preferred configuration provides for the partial key to be transmitted from the mobile apparatus to the local communication apparatus via near field communication. In this manner, near field communication can be used for a dual function, namely both to detect the mobile apparatus and to transmit the partial key.

In order to be able to carry out authorization even before the data record for updating is received, provision is preferably made, in order to update the software package, for the teleapparatus to receive an update notification and for authorization to be carried out following the update notification. In this manner, the update server can therefore announce a pending update.

Since near field communication has only a very short range, exact positioning of the mobile apparatus is necessary for the purpose of establishing near field communication with the mobile apparatus. So that the operator of the motor vehicle can carry out this positioning at the given time, one preferred embodiment provides, in response to the reception of the update notification, for a signaling apparatus of the motor vehicle to output an operator signal to an operator of the motor vehicle in order to establish near field communication with the mobile apparatus.

In order to increase security during authorization, provision may be made, as an additional measure and according to one preferred embodiment, for authorization to presuppose that near field communication with the mobile apparatus has been established within a predefined time after receiving the update notification. In this case, provision may be made for near field communication to also be able to be established even before the update notification is received.

Provision is preferably made for the teleapparatus to transmit a confirmation message to the update server for successful authorization. This confirmation message may comprise an identifier to be checked by the update server or a code to be checked from the mobile apparatus. The confirmation message therefore forms the basis for an entitlement check in the authorization server. This is preferably based on the principle of cryptographic challenge-response methods. Authorization is therefore successful only if the update server has checked the confirmation message in an entitlement check and has found it to be valid. Alternatively, such an entitlement check can also take place in the motor vehicle, in which case the confirmation message transmits the entitlement check which has already been successfully carried out to the update server. An additional entitlement check in the update server is then unnecessary.

In both variants, the practice of providing such a confirmation message makes it possible to carry out authorization even before the data record is transmitted, with the result that the data record is preferably not transmitted if the entitlement check is unsuccessful. However, the authorization process may also comprise overall both an entitlement check of the confirmation message and the decryption of the data record, with the result that authorization is successfully concluded only if both the entitlement check of the confirmation message showed a positive result and the data record was decrypted.

One preferred variant also provides for the teleapparatus to transmit a conclusion message to the update server after the software package has been updated. This is used to inform the update server of the concluded update. This allows both conclusions with respect to the motor vehicle by the update server, for instance if a plurality of attempted updates fail, and information relating to whether particular updates, to which subsequent updates are possibly applied, have not yet been carried out.

In this case, provision is preferably also made for the confirmation message to have cryptographic protection, and for at least one partial key for cryptographically protecting the confirmation message to be provided by the portable mobile apparatus. In this case, this partial key for cryptographically protecting the confirmation message may be identical to the partial key for decrypting the data record for updating. However, it is preferred for the partial key for cryptographically protecting the confirmation message to differ from the partial key for decrypting the data record for updating.

The cryptographic protection of the confirmation message—for instance by means of a digital signature and alternatively or additionally by means of encryption—further increases security. One preferred variant also provides for the conclusion message to also accordingly have such cryptographic protection with the analogously same features.

In order to increase the convenience for the operator, the authorization process can be simplified for him insofar as the operator must only place the mobile apparatus at the location provided for authorization for successful authorization. In the case of an ignition key, this may be, for instance, the ignition lock or, in the case of a mobile telephone or a PDA, a holder specifically provided for this. Accordingly, one preferred embodiment provides for the local communication apparatus to automatically establish near field communication with the mobile apparatus if the mobile apparatus is within the range required for near field communication. The shortness of the range of near field communication readily results in a narrow placement specification. The need for a special input by the operator can be dispensed with according to this preferred embodiment.

The update of the software package may relate purely to the exchange of parameters or useful data, with the result that the executable program code remains the same. One example of this would be the updating of map data for navigation. However, it is preferred for the motor vehicle to comprise a processor apparatus, for the software package to have computer instructions for execution on the processor apparatus and useful data to be processed by the computer instructions, and for the update for the software package to at least partially concern the computer instructions. Therefore, the executable program code can also be replaced or supplemented, with the result that bug fixes and functional enhancements can be carried out, for instance.

In order to further increase the security of the authorization process, provision may be made for the local communication apparatus to be arranged in an interior of the motor vehicle in such a manner that a receiving region, within which near field communication with the mobile apparatus can be established, is likewise arranged in the interior of the motor vehicle. Therefore, the authorized operator must thus also have access to the interior of the motor vehicle for authorization.

The motor vehicle according to the disclosure comprises an electronic data memory with a software package stored in the latter and comprises an authorization apparatus for authorizing an at least partial update of the software package, the software package being updated upon successful authorization.

The motor vehicle according to the disclosure is characterized in that the motor vehicle has a local communication apparatus for near field communication, and in that successful authorization is based on the fact that the local communication apparatus establishes near field communication with a portable mobile apparatus.

Preferred configurations and variants of the motor vehicle according to the disclosure emerge from the preferred embodiments of the method according to the disclosure and vice versa.

Further features and advantages of the disclosure emerge from the following description of an exemplary embodiment which should not be understood as being restrictive and is explained in more detail below with reference to the figures. In the drawing:

### BRIEF DESCRIPTION OF THE DRAWINGS

FIG. 1 schematically shows an exemplary embodiment of a motor vehicle according to the disclosure, and

FIG. 2 schematically shows a flowchart for an exemplary embodiment of a method according to the disclosure.

### DETAILED DESCRIPTION

As required, detailed embodiments of the present disclosure are disclosed herein; however, it is to be understood that the disclosed embodiments are merely exemplary of the disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

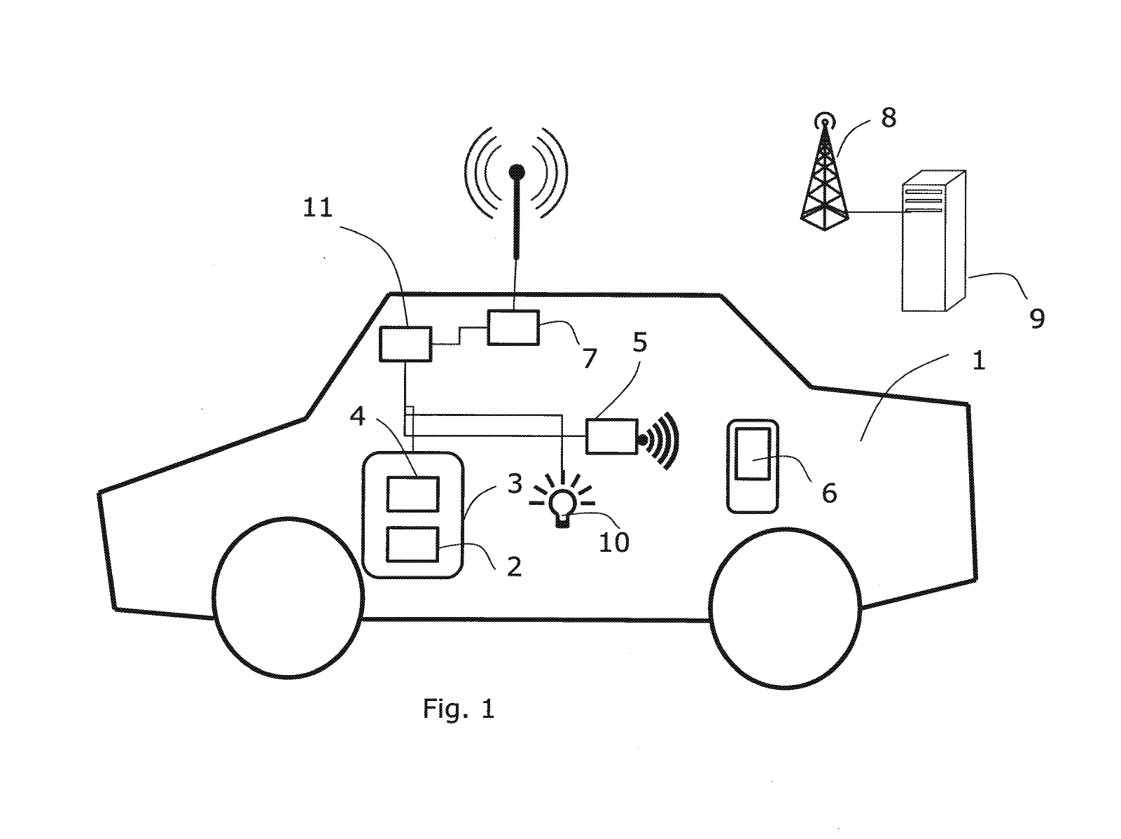

The motor vehicle 1 illustrated in FIG. 1 has an electronic data memory 2 of a driver assistance apparatus 3 of the motor vehicle 1. The driver assistance apparatus likewise has a processor apparatus 4. The data memory 2 stores a software package which comprises both computer instructions for execution on the processor apparatus 4—that is to say program code in the narrower sense—and useful data which are to be processed by these computer instructions and which here are parameter values for the driver assistance apparatus 3.

The motor vehicle 1 likewise has a local communication apparatus 5 which is arranged in an interior of the motor vehicle and specifically communicates according to NFC (near field communication). A portable mobile apparatus 6, which here is a smartphone belonging to the owner of the motor vehicle 1, is arranged in a corresponding holder—not separately illustrated here—in the interior of the motor vehicle 1 and in this respect is within that range of the local communication apparatus 5 in which near field communication can be established. In this case, for automatically establishing—that is to say without a special operating input—near field communication, it suffices for the mobile apparatus 6 to be brought into the range of the local communication apparatus 5 by placing it in this holder.

A teleapparatus 7 of the motor vehicle 1 communicates with a base station 8 by means of a wireless communication protocol—here specifically by means of the LTE (long term evolution) protocol—and, through the base station, liaises with an update server 9 from which the teleapparatus 7 can receive data. The motor vehicle 1 also has a signaling apparatus 10—specifically a lighting arrangement here—which can be used to output an operator signal to the operator of the motor vehicle 1. Specifically here, the operator signal has the purpose of requesting this operator to establish near field communication between the mobile apparatus 6 and the local communication apparatus 5, which can take place here by placing the mobile apparatus 6 in the holder provided for it.

Finally, the motor vehicle has an authorization apparatus 11 which is an electronic on-board computer here. This authorization apparatus 11—and therefore the electronic on-board computer—may also be embodied together with the driver assistance apparatus 3 or any other electronic system having a processor apparatus 4 and an electronic data memory 2, the teleapparatus 7 or the local communication apparatus 5 or else any desired combination of these and other electronic apparatuses in the motor vehicle 1 as an individual electronic device. In this respect, the division which is carried out in this exemplary embodiment and is illustrated in FIG. 1 is purely exemplary. The authorization apparatus 11 is used to carry out authorization which is described in more detail below and the success of which results in the software package stored in the data memory 2 being updated.

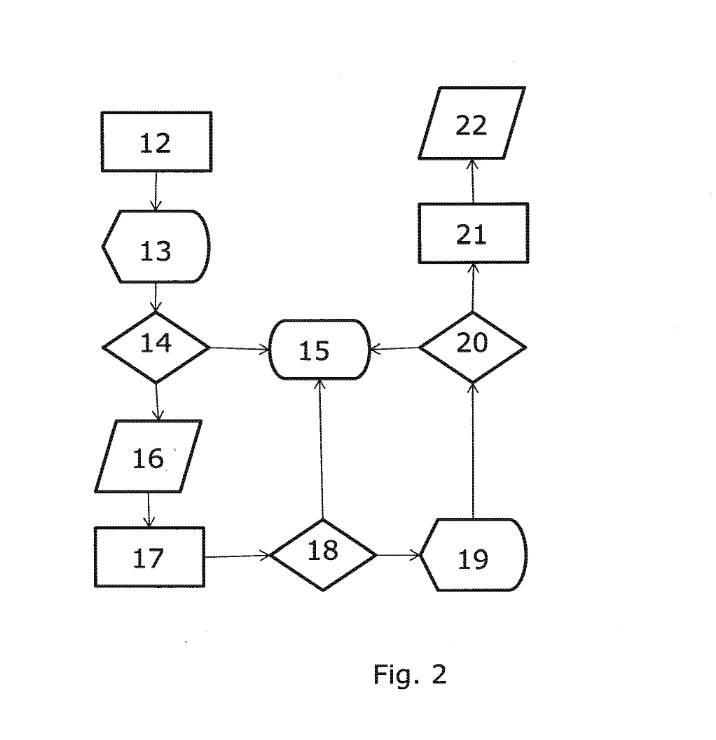

The authorization method illustrated in FIG. 2 is now explained using said FIG. 2. In a—here first—notification step 12 of the method, the teleapparatus 7 receives an update notification transmitted by the update server 9. The received notification is forwarded to the authorization apparatus 11. The authorization apparatus 11 then controls the signaling apparatus 10 to the effect that it generates the—here optical—operator signal in the signaling step 13. The operator signal is directed to the operator. It informs him of the pending update of the software package and requests him, for the purpose of authorization, to place the portable mobile apparatus 6—in particular to place it in the holder provided for this purpose—in such a manner that near field communication is established between the mobile apparatus 6 and the local communication apparatus 5.

After a predetermined time—which is set here at 30 seconds by way of example—has elapsed, a communication checking step 14 checks whether near field communication has been established, that is to say now exists, between the local communication apparatus 5 and the mobile apparatus 6. On account of the automatic establishment of near field communication described above, this is the case when the mobile apparatus 6 was already in the range required for near field communication before signaling—for example as a result of being arranged in the holder—or was brought into this range within the predetermined time.

If near field communication has not been established, failure of the authorization is determined in an abort step 15 and the update is aborted. If near field communication has been established, the local communication apparatus 5 receives an identifier from the mobile apparatus 6 by means of near field communication in an identification step 16, which identifier identifies the mobile apparatus 6 and is cryptographically protected both by means of encryption and by means of a digital signature. A corresponding partial key is provided by the mobile apparatus 6 and is therefore stored in the latter. In particular, the identifier and the partial key may be provided by special identification software in the mobile apparatus 6. In addition to this identifier, the local communication apparatus 5 receives a further partial key which is provided for the purpose of decrypting the data record for updating the software package. This decryption process which is carried out in a subsequent step is described below.

In a transmission step 17 following the identification step 16, the authorization apparatus 11 transmits the identifier received from the local communication apparatus 5 to the update server 9 using the teleapparatus 7.

In a subsequent entitlement step 18, the update server 9 checks whether the received identifier—after its decryption and confirmation of the digital signature—provides entitlement to update the software package in the data memory 2 of the motor vehicle 1. If such an entitlement is not present, the update is aborted in the abort step 15, as described above. Authorization has then failed. If the presence of an entitlement to update the software package is determined, the update server 9 transmits the data record for updating the software package to the teleapparatus 7 in a transmission step 19. The data record is cryptographically protected by means of encryption.

In the subsequent decryption step 20, the authorization apparatus 11 attempts to decrypt the data record for updating the software package, which is read from the teleapparatus 7, with the aid of the partial key for decrypting the data record for updating the software package, which partial key was received in the identification step 16.

If this decryption fails, the abort step 15 again follows with corresponding failure of the authorization as a whole. If decryption is successful, authorization is successful and the authorization apparatus 11 updates the software package stored in the data memory 2 in the subsequent update step 21 by means of the data record for updating the software package.

Finally, the authorization apparatus 11 causes the teleapparatus 7 to transmit a conclusion message to the update server 9 in the conclusion step 22 for the purpose of informing of successful authorization and the update which has been carried out.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

What is claimed is:

1. A method for authorizing a software update in a motor vehicle comprising:
storing a software package on an electronic data memory of the motor vehicle;
establishing a near field communication between a local communication apparatus and a mobile apparatus; and
at least partially updating the software package responsive to a successful authorization performed over the established near field communication between the local communication apparatus and the mobile apparatus.

2. The method of claim 1 further comprising wirelessly receiving, via a teleapparatus of the motor vehicle, a data record for updating the software package from an update server.

3. The method of claim 2, wherein the update server transmits the data record for updating the software package in a broadcast to a multiplicity of teleapparatuses of motor vehicles.

4. The method of claim 2, wherein updating the software package includes transmitting cryptographically-protected data between the teleapparatus and the update server, and at least one partial key is provided by the mobile apparatus for cryptographically protecting the data.

5. The method of claim 4, wherein the cryptographically-protected data comprises the data record for updating the software package, wherein cryptographic protection comprises encryption and the successful authorization comprises decrypting the data record for updating the software package.

6. The method of claim 4, wherein the partial key is transmitted from the mobile apparatus to the local communication apparatus via near field communication.

7. The method of claim 2 further comprising receiving an update notification on the teleapparatus, wherein the update notification further defines the successful authorization for updating the software package.

8. The method of claim 7 further comprising, in response to receiving the update notification, outputting an operator signal using a signaling apparatus to an operator to establish near field communication with the mobile apparatus.

9. The method of claim 8, wherein establishing a near field communication between a local communication apparatus and a mobile apparatus is performed within a predefined time after receiving the update notification to define the successful authorization.

10. The method of claim 2, wherein the successful authorization further includes transmitting, via the teleapparatus , a confirmation message to the update server.

11. The method of claim 10, wherein the confirmation message is cryptographically protected, and wherein at least one partial key for cryptographically protecting the confirmation message is provided by the mobile apparatus.

12. The method of claim 1, further comprising automatically establishing, by the local communication apparatus, the near field communication with the mobile apparatus if the mobile apparatus is within near field communication range.

13. The method of claim 1, wherein the software package includes computer instructions for execution on a processor apparatus and useful data to be processed by the computer instructions, and updating the software package at least partially concerns the computer instructions.

14. The method of claim 1, wherein the local communication apparatus is arranged in an interior of the motor vehicle in such a manner that a receiving region, within which near field communication with the mobile apparatus can be established, is likewise arranged in the interior of the motor vehicle.

15. A vehicle comprising:
an electronic data memory having a software package stored therein;
an authorization apparatus configured to authorize an at least partial update of the software package, the software package being updated upon a successful authorization; and
a local communication apparatus configured to provide wireless near field communication, wherein the successful authorization is defined responsive to the local communication apparatus having established near field communication with a portable mobile apparatus.

16. The vehicle of claim 15, wherein the local communication apparatus is arranged in a vehicle interior such that a receiving region is within a range to establish near field communication with the mobile apparatus within the vehicle interior.

17. The vehicle of claim 16, wherein the local communication apparatus is configured to automatically establish near field communication with the mobile apparatus if the mobile apparatus is within the range.

18. A method of updating software for a vehicle comprising:
in response to receiving an update notification on a teleapparatus, establishing a near field communication between a local communication apparatus and a mobile apparatus within a predefined time after receiving the update notification to define a successful authorization, wherein the teleapparatus transmits a confirmation message to an update server in response to the successful authorization.

19. The method of claim 18, wherein the confirmation message is cryptographically protected data, and at least one partial key for cryptographically protecting the confirmation message is provided by the mobile apparatus.

20. The method of claim 19 further comprising transmitting cryptographically protected data between the teleapparatus and the update server, wherein at least one partial key being provided by the mobile apparatus for cryptographically protecting the data.
